(19) United States
(12) Patent Application Publication
(10) Pub. No.: US 2004/0047483 A1
(43) Pub. Date: Mar. 11, 2004

(54) Hearing aid

(76) Inventor: Natan Bauman, Cheshire, CT (US)

Correspondence Address: BACHMAN & LAPOINTE, P.C., 900 CHAPEL STREET, SUITE 1201, NEW HAVEN, CT, 06510, US

(21) Appl. No.: 10/325,529

(22) Filed: Dec. 18, 2002

Related U.S. Application Data
(63) Continuation-in-part of application No. 10/293,706, filed on Nov. 12, 2002.
Application No. 10/293,706 is a continuation-in-part of application No. 10/241,279, filed on Sep. 10, 2002.

(51) Int. Cl. H04R 25/00

(52) U.S. Cl. 381/330

(57) ABSTRACT

The present invention relates to a system for improving a user's hearing and more particularly to a receiver system used in the system. In one embodiment, the receiver system has a housing and a plurality of arms extending from the housing for positioning and suspending the receiver within the ear canal of a user. Each of the arms may be formed from a flexible, plastic material or a bendable wire. In a second embodiment, the receiver system is surrounded by a disc formed from a sound filtering material. When installed in a combination instrument, the receiver is separated from the microphone. When installed in a tinnitus/hyperacusis device, the receiver is separated from the body of the instrument.

### CROSS-REFERENCE TO RELATED APPLICATION(S)

This application is a continuation-in-part application of U.S. patent application Ser. No. 10/293,706, filed Nov. 12, 2002, to Bauman, entitled HEARING AID SYSTEM, which is in turn a continuation-in-part application of U.S. patent application Ser. No. 10/241,279, filed Sep. 10, 2002, to Bauman, entitled HEARING AID SYSTEM.

### BACKGROUND OF THE INVENTION

The present invention relates to a hearing aid system and in particular to a receiver system used in the hearing aid system.

A wide variety of hearing aid units are known in the art. In some units, the receiver is positioned within the ear canal in such a way that it creates an occlusion effect. Further, the receiver is encased within the body of the hearing aid. In most cases whether the hearing aid is fitted in the ear, as a custom made instrument, or as an instrument which is placed behind the ear, an occlusion problem exists. This often is a cause of rejection of the amplification due to patient's discomfort with their own voice. This occlusion effect is associated with the sensation of feeling that the patient's head is “at the bottom of the barrel” with the patient's own voice becoming intolerably loud. Placing an earmold or a shell of a custom made hearing aid can produce an additional low frequency amplification of the patient's own voice up to20 to 30 dB. This can, therefore, be responsible for a four times perceived loudness increase in the patient's own voice. In order to eliminate the occlusion effect, an open ear canal amplification is applied. However, the acoustics of an open ear fitting increase the risk of acoustic feedback prohibiting in most instances to achieve a peak gain of more than 30 dB.

Thus, there is a need for an improved hearing aid system which avoids the occlusion effect and which also avoids feedback, especially during high frequency amplification.

### SUMMARY OF THE INVENTION

Accordingly, it is an object of the present invention to provide a receiver, receiver placement, and a receiver casing which avoids the occlusion effect.

It is a further object of the present invention to provide a receiver system which helps avoid feedback during high frequency amplification.

It is a further object of the present invention to provide a hearing aid system having a receiver, such as the aforementioned receiver, separated from the microphone.

The foregoing objects are attained by the receiver and the hearing aid system of the present invention.

In accordance with the present invention, a receiver and a receiver casing for use in a system for improving a user's hearing, in a hearing aid system is provided. Also, it is the intention to use same receiver system removed from the body of the instrument to be used in a tinnitus device as described in U.S. Pat. No. 6,048,305. It is essential to have an open ear tinnitus instrument in the tinnitus retraining therapy program. Therefore, this present invention will provide such by having the body of the instrumentation placed behind the ear with the receiver placed in the ear canal without obstructing the external auditory means.

In a first embodiment, the receiver comprises a housing to be positioned within an ear canal and a plurality of arms extending from the housing. The tip portion of each arm contacts a surface of a user's ear canal and suspends the receiver within the ear canal.

In a second embodiment, the receiver is housed in a disc. The disc is formed from a frequency specific filtering material. The disc has an adjustable rim which when placed in the ear canal uses spring like motion to maintain receiver position.

Further, in accordance with the present invention, a hearing aid system is provided. The hearing aid system comprises a microphone located externally of a user's ear canal, an amplifier connected to the microphone to amplify sounds received by the microphone, a receiver positioned within the user's ear canal, and means for transmitting the amplified output to the receiver. As before, the receiver preferably has a housing and a plurality of arms extending from the housing for suspending the receiver within the user's ear canal. Alternatively, the receiver may be housed within a disc structure.

Other details of the hearing aid system of the present invention, as well as other objects and advantages attendant thereto, are set forth in the following detailed description and the accompanying drawings wherein like reference numerals depict like elements.

### BRIEF DESCRIPTION OF THE DRAWINGS

FIG. 1 is a schematic representation of a hearing aid system;

FIG. 2 is a front view of a suspended receiver used in the hearing aid system of FIG. 1;

FIG. 3 is a side view of the receiver of FIG. 2 positioned within a user's ear canal;

FIG. 4 illustrates an alternative embodiment of a suspended receiver in accordance with the present invention;

FIG. 5 illustrates an embodiment of a receiver housed in a disc;

FIG. 6 illustrates a system for connecting the output of an amplifier to a receiver;

FIG. 7 is a schematic representation of a tinnitus/hyperacusis treatment system; and

FIG. 8 is a schematic representation of a hearing aid which includes a tinnitus/hyperacusis treatment system.

### DETAILED DESCRIPTION OF THE PREFERRED EMBODIMENT(S)

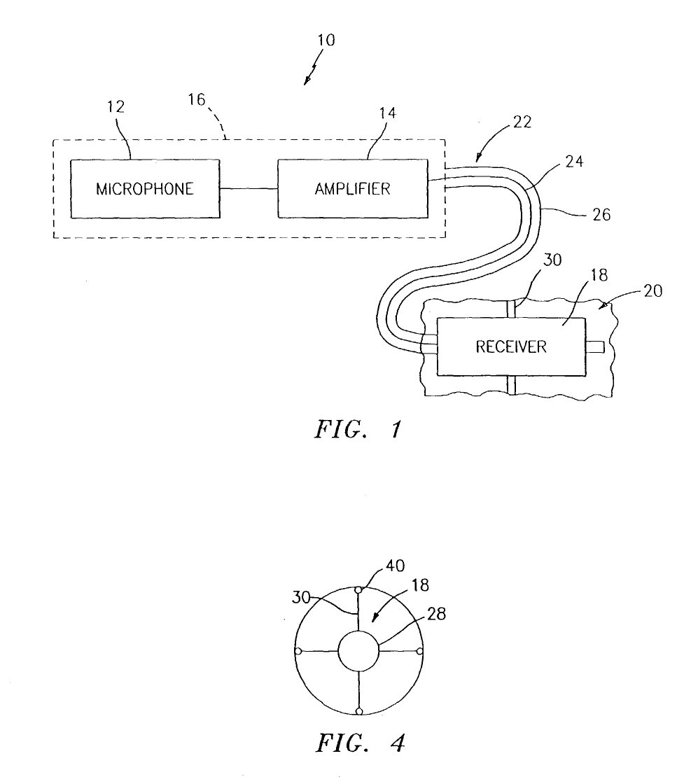

Referring now to the drawings, FIG. 1 illustrates a hearing aid system 10 in accordance with one aspect of the present invention. The hearing aid system 10 includes a microphone 12 and an amplifier 14. The microphone 12 and the amplifier 14 are positioned within a housing 16. The housing 16 may form part of a behind-the-ear unit, part of a unit installed within a user's eyeglass frame, or part of a unit installed within a headset. The hearing aid system 10 may further include a battery (not shown) and means for controlling the hearing aid such as a volume control.

The hearing aid system 10 further includes a receiver 18 which is separated from the housing containing the microphone. The receiver is installed and suspended within the ear canal 20 of a user and means 22 for transmitting amplified output from the amplifier 14 to the receiver 18. The sound transmitting means 22, depending upon the particular kind of amplifier 14 being used, may be a wire 24 encased within a plastic coating 26 housing the wire. When used, the wire 24 makes an electrical contact with the amplifier 14 and the receiver 18 over which electrical output can be transmitted. The plastic coating around the wire 24 helps prevent electrical shocks.

An alternative way of connecting the output from the amplifier 14 to the receiver 18 is shown in FIG. 6. In this approach, there is an arcuately shaped electric contact 70 attached to the amplifier 14 by supports 72. A wire 74 extends between amplifier 14 and the contact 70. The electrical contact 70 is shaped in the manner of a ball socket to receive a ball 76. The ball 76 has an electrical coating on its outer surface 78 and a wire 80 which attaches to the receiver 18.

The microphone 12, the amplifier 14, and the control means may comprise any suitable microphone, amplifier, and control means known in the art. Similarly, the receiver 18 may comprise any suitable receiver known in the art.

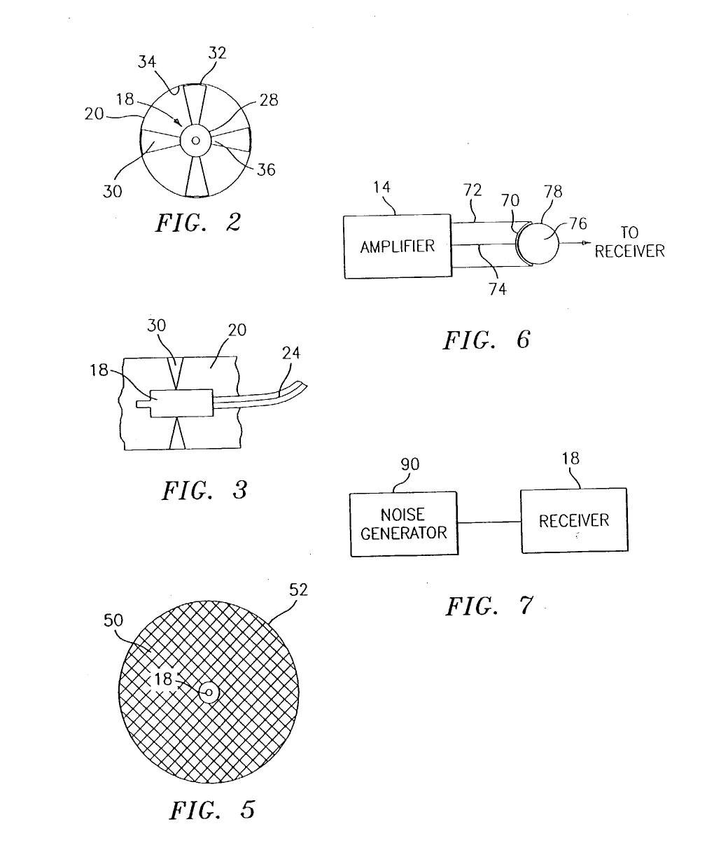

As shown in FIGS. 2 and 3, the receiver 18 has a housing 28. To position and suspend the receiver 18 within the ear canal 20, a plurality of arms 30 extend from the housing 28. Each of the arms 30 is formed from a flexible material such as a flexible plastic material. The tip portions 32 of each arm 30 contact a surface 34 of the ear canal 20 to position the receiver 18 in a desired location in the ear canal 20. As can be seen from FIG. 2, each arm 30 tapers from the tip portion 32 to a base portion 36. In a preferred embodiment of the present invention, the arms 30 are spaced 90 degrees from each other.

The arms 30 are quite advantageous because they allow the receiver 18 to be positioned or suspended in such a way that the receiver 18 does not occlude the ear canal. Further, the arms 30 allow the use of any size of receiver in the hearing aid systems. Still further, the receiver, separated from the microphone, provides a greater flexibility in delivering high frequency amplification without causing or creating feedback. Thus, protection of the ear canal and the separation of the receiver 18 from the microphone 12 allows one to achieve greater high frequency gain without feedback.

Further, a suspended receiver away from the ear canal walls will also provide a better protection from impacting the receiver with cerumen.

While it has been stated that the microphone 12 and the amplifier 14 are in the same housing, it should be noted that they could be in separate housings depending upon the type of hearing aid system 10. For example, if the system 10 is incorporated in an eyeglass frame, the microphone could be in one part of the frame and the amplifier could be in another part of the frame.

While it is preferred to form the arms 30 from a flexible plastic material, each of the arms 30 could also be formed from a bendable wire. When formed from a bendable wire, as shown in FIG. 4, each wire may have a plastic or metal ball 40 at the end which makes contact with a surface of the user's ear canal.

If desired, the length of the insertion of the receiver 18 in the ear canal 20 can be adjusted using a retractable wire 24 from the sound transmitting means 22 or by replacing the ear hook on a behind the ear hearing aid unit.

Referring now to FIG. 5, an alternative receiver embodiment is illustrated. The receiver 18 is housed within a disc 50 of exchangeable sound filtration material. The material forming the disc 50 may be formed from a paper or fabric like material which is transparent to most sound except sound which is to be filtered out. By making the disc 50 exchangeable or replaceable, one can mechanically change the frequency response of sounds that are escaping out of the hearing aid. One can also filter out any frequency that causes feedback. The disc 50 is preferably formed with a rim 52 that flexes, such as a rim formed from a spring-like material, in order to maintain the position of the receiver 18 and disc 50 in a desired position in the ear canal.

While the receiver 18 of the present invention has been described in the context of hearing aid systems, the receiver could also be used in tinnitus treatment systems. For example, as shown in FIG. 7, a noise generator 90 may be positioned behind the wearer's ear in lieu of the microphone or amplifier and attached to a receiver 18 positioned within the user's ear canal. The noise generator 90 generates sounds to be transmitted to the tympanic membrane for the treatment of tinnitus/hyperacusis. The receiver 18 may have a disc 50 surrounding it or a plurality of arms 30 radiating from it in order to position it within the ear canal. The disc 50 and the arms 30 may have the structure described hereinbefore.

While the receiver 18, when used in either the context of a hearing aid system or a tinnitus treatment system, has been described as being connected to an amplifier 14 or a noise generator 90 by a wire, it should be recognized that the receiver 18 could be disconnectable so that it can be separated from the body of the instrument to which it is connected. Any suitable means known in the art may be used to render the receiver 18 disconnectable.

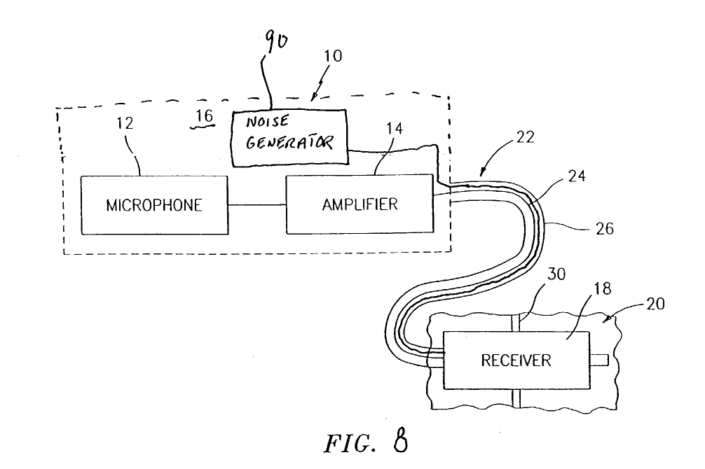

In yet another embodiment of the present invention as shown in FIG. 8, the hearing aid system 10 may have an amplifier 14 and a noise generator 90 located within a housing 16. Additionally, the housing 16 may include a microphone 12, although the microphone 12 could be separate from the housing 16 if desired. The amplifier 14 and the noise generator 90 are each connected to a receiver 18 positioned within the user's ear canal in such a way that the receiver 18 does not occlude the ear canal. The amplifier 14 and the noise generator 90 may be connected to the receiver 18 using any suitable means known in the art including, but not limited to, the connection means shown in FIG. 6. If desired, both the amplifier 14 and the noise generator 90 may be disconnectable from the receiver 18. The amplifier 14 may comprise any suitable programmable digital amplifier known in the art. The noise generator 90 is preferably a programmable digital noise generator which may be used to generate sounds to be transmitted to the tympanic membrane for the treatment of tinnitus/hyperacusis.

The hearing aid system shown in FIG. 8 provides numerous advantages. The most significant of these advantages is that a user can be provided with both a hearing aid and a noise generator for combating tinnitus/hyperacusis in a single unit. Another advantage is that both the amplifier and the noise generator may be located in a unit which can be placed behind the user's ear.

It is apparent that there has been provided in accordance with the present invention a hearing aid system which fully satisfies the objects, means, and advantages set forth hereinbefore. While the present invention has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed is:

1. A receiver for use in a system for improving a user's hearing comprising a housing to be positioned within an ear canal, said housing having a plurality of arms extending from said housing, and a tip portion of each of said arms contacting said ear canal to suspend the receiver in the ear canal.

2. A receiver according to claim 1, further comprising means for transmitting amplified sound connected to said housing.

3. A receiver according to claim 2, wherein said amplified sound transmitting means comprises a wire coated with a plastic material connected to said receiver.

4. A receiver according to claim 1, wherein said receiver is disconnectable.

5. A receiver according to claim 1, wherein said plurality of arms comprises four arms spaced ninety degrees apart.

6. A receiver according to claim 1, wherein each said arm is formed from a flexible material.

7. A receiver according to claim 1, wherein each said arm is formed from a plastic material.

8. A receiver according to claim 1, wherein each said arm is formed from a bendable wire.

9. A receiver according to claim 1, wherein each said arm has a base portion and tapers from said tip portion to said base portion.

10. A hearing aid system comprising a microphone located externally of an ear canal of a user, an amplifier connected to said microphone for amplifying sounds received from said microphone, a receiver positioned within said user ear canal, and a means for transmitting amplified sound from said amplifier to said receiver.

11. A hearing aid system according to claim 10, wherein said receiver has a housing and a plurality of arms extending from said housing, said arms contacting said user ear canal to position said receiver within said ear canal.

12. A hearing aid system according to claim 10, wherein said microphone and said amplifier are positioned within a behind the ear unit.

13. A hearing aid system according to claim 10, wherein said amplified sound transmitting means comprises a wire with a plastic coating.

14. A hearing aid system according to claim 10, wherein said amplified sound transmitting means comprises an electrical contact connected to said amplifier and a ball with an electrical coating attached to said receiver and contacting said electrical contact.

15. A hearing aid system according to claim 10, wherein said receiver is disconnectable.

16. A hearing aid system according to claim 11, wherein each of said arms has a base portion and a tip portion and each of said arms tapers from said tip portion to said base portion.

17. A hearing aid system according to claim 11, wherein said plurality of arms comprises four arms spaced about the periphery of said housing.

18. A hearing aid system according to claim 17, wherein each of said four arms is spaced from an adjacent arm by an angle of ninety degrees.

19. A hearing aid system according to claim 11, wherein each of said arms is formed from a flexible material.

20. A hearing aid system according to claim 11, wherein each of said arms is formed from a plastic material.

21. A hearing aid system according to claim 11, wherein each of said arms is formed from a bendable wire.

22. A hearing aid system according to claim 21, wherein each said wire has a ball at an end making contact with a surface of the user's ear canal.

23. A hearing aid system according to claim 10, wherein said receiver is housed within a disc positioned within the user's ear canal.

24. A hearing aid system according to claim 23, wherein the disc is formed from a sound filtering material.

25. A hearing aid system according to claim 23, wherein the disc has a rim formed from a flexible material.

26. A hearing aid system according to claim 23, wherein the disc is replaceable.

27. A receiver system for use in a system for improving a user's hearing comprising a receiver and disc surrounding said receiver for positioning the receiver within a user's ear canal.

28. A receiver system according to claim 27, wherein said disc is formed from a sound filtering material.

29. A receiver system according to claim 27, wherein said disc has a flexible rim.

30. A receiver system according to claim 27, wherein said disc is replaceable.

31. A system for treating tinnitus comprising:
a receiver positioned within a user's ear canal;
means for generating sounds to be transmitted to the tympanic membrane for treating tinnitus and hyperacusis; and
means for connecting said receiver to said sound generating means.

32. A system according to claim 31, wherein said sound generating means is located externally of said ear canal.

33. A system according to claim 31, further comprising a disc surrounding said receiver for positioning the receiver within a user's ear canal.

34. A system according to claim 33, wherein the disc is formed from a sound filtering material and has a flexible rim.

35. A system according to claim 31, further comprising a plurality of arms radiating from said receiver to position said receiver within said ear canal.

36. A system according to claim 35, wherein each arm is formed from a flexible material.

37. A system according to claim 35, wherein each arm has a ball at an end remote from said receiver.

38. A system according to claim 31, wherein said receiver is disconnectable.

39. A combination tinnitus and hearing aid instrument, comprising:
a receiver positioned within an ear canal of a user;
said receiver not occluding said ear canal;
an amplifier connected to said receiver; and
a noise generator for generating noise sufficient to treat tinnitus attached to said receiver.

40. A combination instrument according to claim 39, wherein said amplifier is a programmable digital amplifier and said noise generator is a programmable digital noise generator.

41. A combination instrument according to claim 39, wherein said receiver is disconnectable from said amplifier and said noise generator.

42. A combination instrument according to claim 39, further comprising a microphone attached to said amplifier.
